(19) United States
(12) Patent Application Publication
(10) Pub. No.: US 2009/0144142 A1
(43) Pub. Date: Jun. 4, 2009

(54) Postal article re-addressing and re-delivery using smart mailer

(76) Inventor: Michael J. Ure, Cupertino, CA (US)

Correspondence Address: MICHAEL J. URE, 10518 PHIL PLACE, CUPERTINO, CA, 95014, US

(21) Appl. No.: 11/950,263

(22) Filed: Dec. 4, 2007

(51) Int. Cl. G06Q 10/00; G06Q 30/00; G06K 9/00

(52) U.S. Cl. 705/14; 705/1; 705/26; 382/100

(57) ABSTRACT

A system allows for more efficient circulation of articles through the postal system. In accordance with one embodiment of the invention, a smart mailer is provided having wireless communication and display capabilities. When an article is to be returned through the postal system, the postman uses a portable terminal (such as a cellphone) to check in the article and, at the same time, re-address the article for delivery to a subsequent (preferably local) customer. Preferably, these actions are both performed by a simple swiping of the portable terminal with respect to the article. Back-office infrastructure is provided for accounting of postal charges, etc. The utility of the portable terminal may be further increased by incorporating barcode reading capability, GPS capability, etc. The system may be used for articles of all descriptions, but is especially suited for smaller articles including media (recordings, books), jewelry, etc.

### BACKGROUND

1. Field of the Invention

The present invention relates to postal services and internet commerce (“e-tailing”).

2. State of the Art

Netflix of Los Gatos, Calif. uses the postal service to deliver rental media, namely video discs. After each rental, a disc is returned to Netflix and “checked-in” for subsequent deliver to another customer. Although the articles in question—video discs—are compact, infrastructure requirements to handle a large volume of articles remain significant. Postal charges are substantial.

An system is needed to allow for more efficient circulation of articles through the postal system.

### SUMMARY

The present invention, generally speaking, provides a system to allow for more efficient circulation of articles through the postal system. In accordance with one embodiment of the invention, a smart mailer is provided having wireless communication and display capabilities. When an article is to be returned through the postal system, the postman uses a portable terminal (such as a cellphone) to check in the article and, at the same time, re-address the article for delivery to a subsequent (preferably local) customer. Preferably, these actions are both performed by a simple swiping of the portable terminal with respect to the article. Back-office infrastructure is provided for accounting of postal charges, etc. The utility of the portable terminal may be further increased by incorporating barcode reading capability, GPS capability, etc. The system may be used for articles of all descriptions, but is especially suited for smaller articles including media (recordings, books), jewelry, etc.

### DESCRIPTION OF DRAWING

The foregoing may be further understood from the following description in conjunction with the appended drawing. In the drawing:

FIG. 1 is a block diagram of a system for postal article re-addressing and re-delivery using smart mailers.

FIG. 2 is a plan view of a smart mailer.

FIG. 3 is side view of the smart mailer of FIG. 2.

FIG. 4 is an illustration of the display contents of the display of the smart mailer at one stage of the circulation process.

FIG. 5 is an illustration of the display contents of the display of the smart mailer at another stage of the circulation process.

FIG. 6 is an illustration of the display contents of the display of the smart mailer at another stage of the circulation process.

FIG. 7 is an illustration of the display contents of the display of the smart mailer at another stage of the circulation process.

FIG. 8 is an illustration of the display contents of the display of the smart mailer at another stage of the circulation process.

FIG. 9 is a block diagram of electronic circuitry of the smart mailer.

### DETAILED DESCRIPTION

Referring now to FIG. 1, a block diagram is shown of a system for postal article re-addressing and re-delivery using smart mailers. Various entities in the system communicate via the internet and the wireless web (I).

Users U1-Um place orders for articles through the internet, the orders being handled by servers (S). In this respect alone, the system may be similar to well-known electronic commerce systems, an example of which is the electronic commerce system of Amazon.com. The system further includes, however, portable terminals PT1-PTn, to be described more fully below. A portable terminal is connected via the wireless web and is carried by a postman, or postal carrier. The portable terminal may be a cellphone provided with wireless web capabilities and an RFID reader/writer that uses Near-Field Communications (NFC), for example. One NFC-enabled phone is the Nokia model 3220 (used in a public trial of NFC at Philips Arena in Atlanta, Ga. in 2006). In Japan, mobile phone manufacturer Docomo sells NFC-enabled phones.

The utility of the portable terminal may be further increased by incorporating barcode reading capability, GPS capability, etc. GPS capability allows for fleet tracking and postal carrier tracking. In one embodiment, barcode reading capability is provided using the existing camera of a cellphone and image processing software. Image processing may be performed on the cellphone or at a server. Instead of using the image finder of the cellphone, a laser diode may be provided that is focused when the camera is located at the correct distance from the barcode and is defocused at greater or lesser distances. In operation, a first switch is used to turn on the laser diode. The beam spot of the laser diode is centered on the barcode and the camera is positioned so that the beam spot is focused. Another switch is then actuated to take a picture of the barcode, which picture is then processed to read the information of the barcode. Alternatively, instead of the user deciding when to snap the picture, the device itself may enter a video mode when the first switch is actuated, detect when proper focus is achieved, and snap the picture at that time, giving an audible (or other) indication to the user.

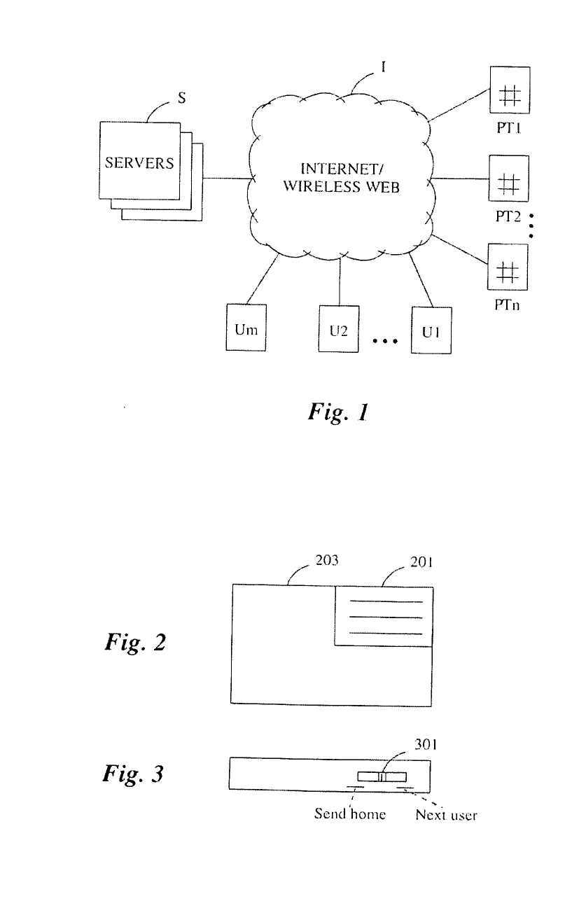

When an order is received and filled, the article is shipped in a smart mailer having a display and provided with NFC capabilities. A plan view of such a smart mailer is shown in FIG. 2. The smart mailer may be imagined as a plastic enclosure (preferably clear) similar to a videotape case and having a display 201 provided on a main surface 203 of the enclosure. The contents of the display and how those contents are varied at different stages of circulation of the article will be described shortly. At the time of placing the order, the customer may choose between delivery options, e.g., standard delivery, priority delivery, etc.

FIG. 3 shows a side view of one embodiment of the smart mailer. A momentary-contact sliding switch 301 is provided having a center default position, a right position and a left position. The right position may be labeled “NEXT USER,” or similar. The left position may be labeled “SEND HOME,” or similar. The switch may take a myriad of different forms and may be actuated mechanically, optically, acoustically (for example using DTMF tones from a phone), etc. Furthermore, instead of having pre-labeled switch options, actuation of the switch may cause different menu options displayed on the display to be highlighted and dimmed in turn. Such an arrangement enables more explicit state information to be captured and allows for progressive refinement of the system. In one embodiment, an area of the enclosure overlying the display is thinned to allow for flexibility, and a membrane switch is positioned behind the display in this area. A switch graphic is displayed on the display in the same area.

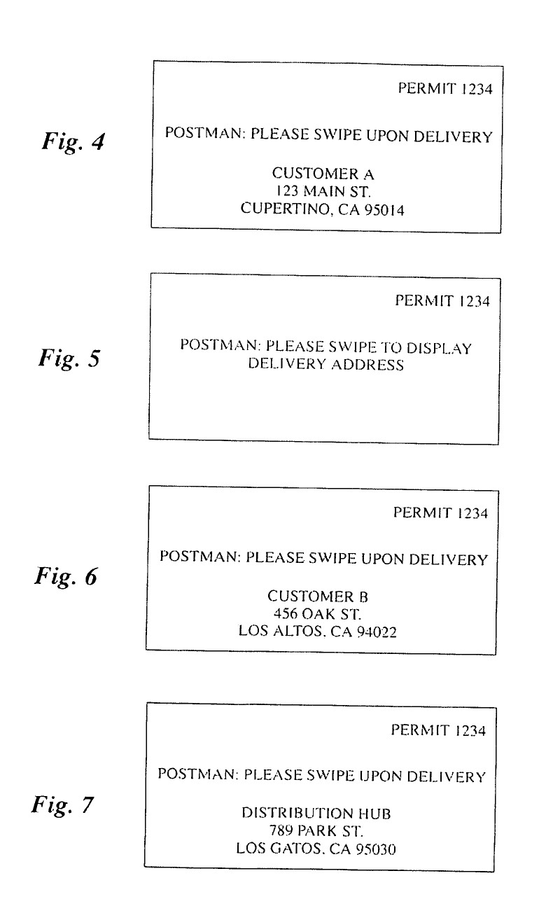

When the article is first sent through the mails, the display may have contents as illustrated, for example, in FIG. 4. A postal permit number is displayed, together with a customer address and a reminder to the postman to swipe the smart mailer upon delivery. When the postman swipes the smart mailer upon delivery, this reminder is removed from the display, and notification is sent to the servers that delivery has been made.

The present system is especially advantageous for video discs, which have high turnover and therefore benefit the most from postal savings. The present system is also advantageous for books (including various types of books—pleasure reading especially, but also professional books, textbooks, etc.), allowing for a “try-before-you-buy” distribution model. The user may keep the book as long as he or she wishes, including permanently if so desired, without paying more than the cost of the book plus shipping. When the user is finished with the book and expects to have no further need of it and no desire to own the book, he or she simply places it in the smart mailer for pickup by the postman and activates the switch to the NEXT USER position. The book does not become bookshelf (or garage) clutter.

Referring to FIG. 5, when the switch is activated to the NEXT USER position, a message. “POSTMAN: PLEASE SWIPE TO DISPLAY ADDRESS, ” or similar, is displayed. When the postman swipes the smart mailer, the servers are alerted that the article is ready to be sent to a next user. The servers match the now-available article with a suitable pending order and send a corresponding address to the portable terminal, which communicates that address to the smart mailer to be displayed on the display of the smart mailer, as shown in FIG. 6. Because of network latency, it may be necessary to perform two separate swiping actions, one to “check-in” the article and one to apply the next delivery address.

If the switch is instead activated to the SEND HOME position, then when the postman swipes the smart mailer, the address communicated to the smart mailer is that of a distribution hub as shown in FIG. 7. The smart mailer may be empty, in the event that the user has decided to own the book, or the book may be returned on account of damage that renders it unsuitable for the next user. A sticker bearing a “fail-safe” address may also be applied to the smart mailer in case the smart mailer becomes disabled.

In some instances, even when the switch has been activated to the NEXT USER position, the address communicated to the smart mailer may that of a distribution hub to allow a program of statistical quality control to be implemented.

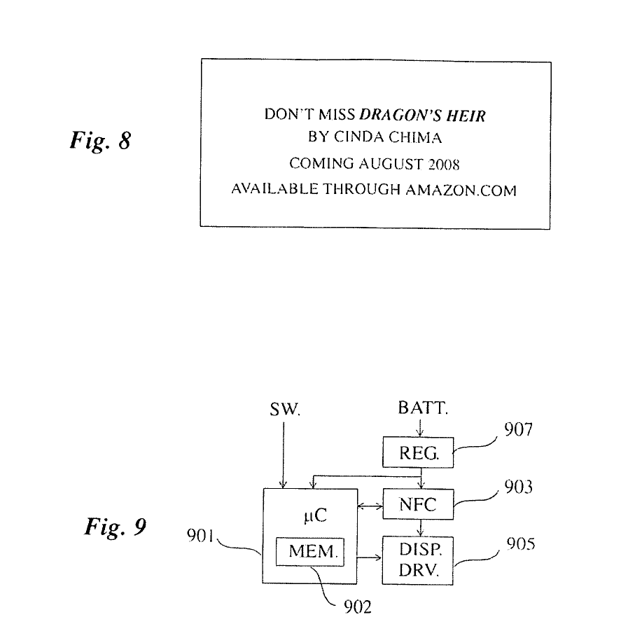

The smart mailer may also serve as an ad deliver vehicle, for example displaying a different promotional ad each day, or more frequently (e.g., morning, noon, and night). The ads may be downloaded in compressed format in the same manner as customer addresses. An example of such an ad is shown in FIG. 8. In the case of a monochrome QVGA display, fifty ads suitably compressed may occupy less than 100 kB, a relatively modest amount of storage. The ads may be selected based on recommender technology of a know type—the recommender technology of Netflix, for example.

The display of the smart mailer may be a plastic substrate cholesteric LCD (ChLCD) display of a type available from Kent Displays Incorporated of Kent Ohio, USA. ChLCDs offer certain advantages in the application of a mobile electronic device. ChLCD displays are low-power, an important characteristic in mobile applications. They are non-volatile, meaning that display content is persistent without the need for display refresh. Furthermore, they do not require backlighting. Backlights consume considerable power. Finally, the plastic substrate makes the display inexpensive and rugged.

Other types of displays, however, including E-Ink™ displays, color STN LCD displays, OLED displays, or other color flat-panel displays, may also be used to advantage where cost and power constraints allow. OLED displays may be particularly well-suited because of their compatibility with plastic substrates.

Referring to FIG. 9, a block diagram is shown of electronic circuitry of one embodiment of the smart mailer. The circuitry includes a microcontroller 901 (including memory 902), an NFC circuit 903, a display driver 905 and a voltage regulator 907. The circuitry receives a battery voltage (BATT.) and switch input signals (SW.). The circuitry, together with a battery and a switch, may be combined as a module having a plug connection for the display. A small hollow compartment may be formed in the spine of the smart mailer enclosure to receive the module.

In alternative embodiments, instead of portable terminals, conventional scanners and office-based equipment is used. In this embodiment, a bar code is displayed on the display, uniquely identifying the article for purposes of postal delivery. Upon delivery, the bar code is scanned using a conventional scanner, and the date and time of delivery is recorded. When the postman returns to the post office, information from the scanner is uploaded to the servers. When an article is picked up, the prompt “POSTMAN: PLEASE SWIPE TO DISPLAY ADDRESS” remains displayed until the article arrives at the post office. At the post office, using office-based equipment provided with NFC capability, the article is scanned as previously described. In this embodiment, a collection of articles may be interrogated and readdressed without the need to handle each article separately. Network latency therefore becomes less of an issue than in the first-described embodiment.

Smart mailers may also be used by free public libraries to maximize circulation of the most popular catalog items, with the patrons paying postal charges.

In the following claims, the phrase “in the field” is used to mean outside the possession of the owner of the item.

It will be appreciated by those of ordinary skill in the art that the present invention can be embodied in other specific forms without departing from the spirit or essential character thereof. The described embodiments are therefore considered in all respects to be illustrative and not restrictive. The scope of the invention is given by the appended claims, not the foregoing description, and all changes which come within the meaning and range of equivalents thereof are intended to be embraced therein.

What is claimed is:

1. A postal distribution method using a smart mailer, comprising:
causing the smart mailer to electronically display a first postal address; and
wirelessly communicating a second postal address to the smart mailer, the smart mailer electronically displaying the second postal address.

2. The method of claim 1, further comprising causing the smart mailer to display a plurality of promotional advertisements at intervals.

3. The method of claim 1, further comprising wirelessly communicating promotional advertisements to the smart mailer.

4. A method of distribution comprising:
receiving an internet order for an item, units of which cue already in the field; and
receiving a message that a unit of the item in the field has become available.

5. The method of claim 4, further comprising sending a delivery address to be applied to the item in the field.

6. The method of claim 5, wherein the delivery address is applied to the unit of the item by a carrier service.

7. The method of claim 5, wherein the carrier service applies the delivery address to the unit of the item at a point of pickup.

8. A distribution system comprising one or more computer servers for:
receiving an internet order for an item, units of which are already in the field: and
receiving a message that a unit of the item has become available.

9. The system of claim 8, wherein the computer servers send a delivery address to be applied to the unit of the item.

10. The system of claim 9, comprising a smart mailer for enclosing the unit of the item, wherein the delivery address is applied to the unit of the item at a point of pickup, the smart mailer electronically displaying the delivery address.

11. A smart mailer comprising:
an article enclosure;
wireless communication circuitry for receiving a postal address; and
a display for displaying the postal address received by the wireless communication circuitry.

12. The smart mailer of claim 11, wherein the display is a non-volatile display.

13. The smart mailer of claim 12, wherein the wireless communication circuitry is NFC wireless communication circuitry.

14. A method of reading a barcode, comprising:
taking a picture of the barcode using a camera phone; and
processing the picture to read the information of the barcode.

15. A method of book vending, comprising
electronically tracking when a book is delivered to a customer;
electronically tracking if and when the book is relinquished;
if the book is relinquished within a period of time, electronically charging the customer based on time of use of the book; and
if the book is not relinquished within a period of time, charging the customer based on the value of the book.
